(19) United States
(12) Patent Application Publication
(10) Pub. No.: US 2008/0063122 A1
(43) Pub. Date: Mar. 13, 2008

(54) Method for suppressing co-channel interference from different frequency

(76) Inventors: Gwo-Jia Jong, Kaohsiung City (TW); Gro-Jium Horng, Kaohsiung City (TW); Jiun-Chiang Huang, Kaohsiung City (TW)

Correspondence Address: GWO-JIA JONG, No. 125, Chien-Min Road, Kaohsiung City, omitted

(21) Appl. No.: 11/516,448

(22) Filed: Sep. 7, 2006

(51) Int. Cl. H04B 1/10

(52) U.S. Cl. 375/350

(57) ABSTRACT

One kind of the technology that can be suppressed the co-channel interference from different frequency. In this work, it can be separated two-transmission signals when the system is adopted the phase-locked loop (PLL) with the amplitude-locked loop (ALL) system in the receiver, and it also can be suppressed the co-channel interference. Finally, the signals through the adaptive filter for the least-mean square (LMS) algorithm to suppress the noise. The ALL is a high gain, high bandwidth servo-loop operation in the amplitude domain rather than the frequency domain. The output of the ALL can be described by the reciprocal of the additive envelope. It is proposed to apply a similar technique to FSK modulation methods. This will result in major improvements in digital communication system and could easily lead to increase the channel capacity of a CDMA (Code-division Multi-access) cellular phone system and any others existing schemes.

### FIELD OF THE INVENTION

One kind of the technology that can be suppressed the co-channel interference from different frequency. In this work, it can be separated two-transmission signals when the system is adopted the phase-locked loop (PLL) with the amplitude-locked loop (ALL) system in the receiver, and it also can be suppressed the co-channel interference. Finally, the signals through the adaptive filter for the least-mean square (LMS) algorithm to suppress the noise. The ALL is a high gain, high bandwidth servo-loop operation in the amplitude domain rather than the frequency domain. The output of the ALL can be described by the reciprocal of the additive envelope. It is proposed to apply a similar technique to FSK modulation methods. This will result in major improvements in digital communication system and could easily lead to increase the channel capacity of a CDMA (Code-division Multi-access) cellular phone system and any others existing schemes; and this algorithm can be extended to multiple-channel signal separation based on adaptive filtering for the

### BACKGROUND OF THE INVENTION

This invention relates to electronic circuits, and more particularly to electronic circuits having amplitude loop-locked (ALL) system combined with the adaptive filter.

In 1933 De Bellicise in France invented a category of circuitry generally called the Phase Locked Loop (PLL). Although a number of decades elapsed before the PLL was fully understood it is now used as a basic building block in many telecommunications, computer and consumer products.

This invention concerns a new category of circuitry which will be hereafter referred to as the Amplitude Locked Loop (ALL) since it embodies all the principles of the PLL but operates in the amplitude domain or real domain and not in the frequency or imaginary domain.

### SUMMARY OF THE INVENTION

This invention presented the results of simulation experiments that successfully demonstrate FM co-channel signal separation by the phase-locked loop (PLL) with the amplitude-locked loop (ALL) system. The method does not require coding process from modulation, when signals are conveyed by co-channel transmission.

To achieve above objects, the present invention provides one kind of the technology that can be suppressed the co-channel interference from different frequency. In this work, it can be separated two-transmission signals when the system is adopted the phase-locked loop (PLL) with the amplitude-locked loop (ALL) system in the receiver, and it also can be suppressed the co-channel interference. Finally, the signals through the adaptive filter for the least-mean square (LMS) algorithm to suppress the noise. The ALL is a high gain, high bandwidth servo-loop operation in the amplitude domain rather than the frequency domain. The output of the ALL can be described by the reciprocal of the additive envelope. It is proposed to apply a similar technique to FSK modulation methods. This will result in major improvements in digital communication system and could easily lead to increase the channel capacity of a CDMA (Code-division Multi-access) cellular phone system and any others existing schemes; and this algorithm can be extended to multiple-channel signal separation based on adaptive filtering for the further.

The various objects and advantages of the present invention will be more readily understood from the following detailed description when read in conjunction with the appended drawing.

### BRIEF DESCRIPTION OF THE DRAWINGS

FIG. 1 shows the Separation System Model of the present invention.

FIG. 2 shows the FM Receiver System of the present invention.

FIG. 3 shows the AGC and ALL System according to the present invention.

FIG. 4 shows the Basic ALL System of the present invention.

FIG. 5 shows the Adaptive Noise Cancellation structure according to the present invention.

FIG. 6 shows the LMS Filter Model of the present invention.

FIG. 7 shows the Simulation of Transmission System of the present invention.

FIG. 8 shows the Receiver Signal from the PLL system according to the present invention.

FIG. 9 shows the Separation Signal from the ALL System of the present invention.

FIG. 10 shows the Separation Signal Via the LMS Filter of the present invention.

FIG. 11 shows the FPGA implementation method using Xilinx System according to the present invention.

FIG. 12 shows the FPGA model used to develop and verify the PLL and ALL in the present invention.

FIG. 13 shows the original modulating signal of the present invention.

FIG. 14 shows another original modulating signal of the present invention.

FIG. 15 shows the Dominant cosine signal s₁(t) by FPGA according to the present invention.

FIG. 16 shows the Subdominant cosine signal s₂(t) by FPGA according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

A Field Programmable Gate Array (FPGA)-based on the Amplitude-Lock Loop (ALL) separation model is developed. The Simulink and Xilinx System Generator is adopted for the co-channel FM separated design system. The signal separated components that require Phase-Locked Loop (PLL), and ALL designed by the Xilinx FPGA block and implemented on SignalWAVe board. The approach is investigated by using high-level tools to map a signal separation algorithm for the reconfigurable hardware. Firstly, the separation model is simulated by using Matlab/Simulink. Secondary, the performance is also compared the outputs of the FPGA implementation and Simulink.

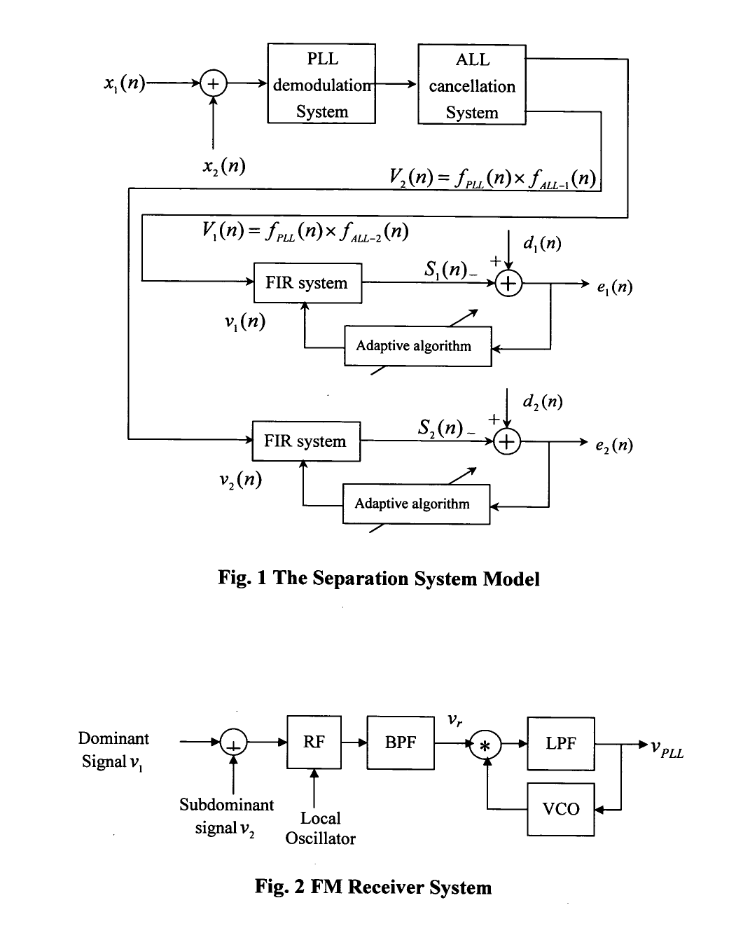

The system model is shown in FIG. 1. At the antenna, a two constant amplitude and phase signal components overlapping both in sampled time and frequecy band is considered. The FM demodulated was shown in FIG. 2. The complex representation of such a signal is

$${v}_{r} ( n ) = {A}_{c} \sqrt{1 + 2 m cos {ω}_{d} n + {m}^{2}} cos ( {ω}_{c} n + {β}_{1} sin {ω}_{1} n + {tan}^{- 1} \frac{m sin {ω}_{d} n}{1 + m cos {ω}_{d} n} ) \qquad ( 1 )$$

The parameters A_{c}, m, ω_{d}, ω_{C}, β₁ sin ω₁t are represented the amplitude of dominant carrier, interfering carrier to wanted carrier ratio, instantaneous frequency, carry frequency and dominant signal of modulation, respectively. We use an automatic gain control (AGC) to normalize the input amplitude variations, so that the dominant carrier may be defined as the unit amplitude and the subdominant carrier has the amplitude of m. For simplicity, we assume that the mean amplitude of both carriers varies only slowly with sampled time.

In the FIG. 2, the received signal was demodulated by the PLL system. It can be found the result that can't separate perfectly by PLL system. The signals was demodulated as:

$${f}_{PLL} ( n ) = \frac{1 + m cos {ω}_{d} n}{1 + 2 m cos {ω}_{d} n + {m}^{2}} {S}_{1} + \frac{{m}^{2} + m cos {ω}_{d} n}{1 + 2 m cos {ω}_{d} n + {m}^{2}} {S}_{2} \qquad ( 2 )$$

S₁, S₂, and n are the dominant signal, subdominant signal, and discrete time, respectively.

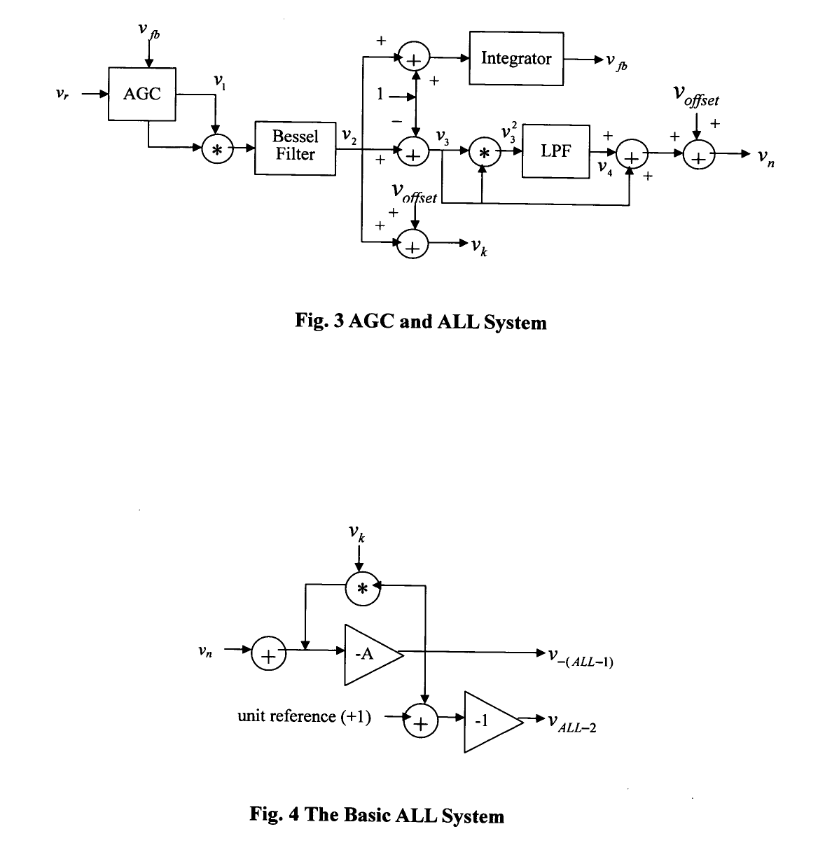

FIG. 3 shows the AGC and ALL system can be found in the bandwidth of the AGC loop is made small so that the instantaneous variations m cos ω_{d}n of will pass through unmodified. Since the higher frequency terms can't pass through the integrator and the feedback control voltage v_{fb} may be defined as:

$$\begin{matrix}{v}_{fb} = \frac{1}{{A}_{c} \sqrt{1 + {m}^{2}}} \\ So & ( 3 ) \\ {v}_{1} = \sqrt{\frac{1 + 2 m cos {ω}_{d} n + {m}^{2}}{1 + {m}^{2}}} cos ( {ω}_{c} n + {β}_{1} sin {ω}_{1} n + {tan}^{- 1} \frac{m sin {ω}_{d} n}{1 + m cos {ω}_{d} n} ) & ( 4 )\end{matrix}$$

### After the squaring and Bessel filtering stages, the output of AGC loop ν₂ becomes:

$${v}_{2} = \frac{1 + 2 m cos {ω}_{d} n + {m}^{2}}{1 + {m}^{2}} \qquad ( 5 )$$

### We let variable m′ as the following

$${m}^{′} = \frac{2 m}{1 + {m}^{2}} \qquad ( 6 )$$

Then Eq. (5) can be replaced as the following:

ν₂=1+m′ cos ω_{d}n (7)

### The next stage is to remove the dc term to obtain the function

$$\begin{matrix}{v}_{3} = - 1 + {v}_{2} = {m}^{′} cos {ω}_{d} n & ( 8 ) \\ {v}_{3}^{2} = \frac{1}{2} {m}^{′2} + \frac{1}{2} {m}^{′2} cos 2 {ω}_{d} n & ( 9 )\end{matrix}$$

Multiplying m′ cos ω_{d}n by ν₃, show as FIG. 3, it is the squared function of ν₃, scaled and a low-pass filter. A low pass filter can remove the double frequency term 2ω_{d}n to scale and obtain ν₄.

ν₄=m′² (10)

The ALL circuit consists of a high gain operational amplifier (OPA) with a linear multiplier in the feedback path. The output of the ALL is the quotient of the input numerator 1+m′ cos ω_{d}n and the input denominator 1−m′². From FIG. 4, we obtain

νₙ=m′²+m cos ω_{d}n+ν_{offset} (11)

νₖ=1+m′ cos ω_{d}n+ν_{offset} (12)

The processing procedure of the ALL function is described in FIG. 4. The equation can be written as:

$${f}_{ALL} ( {m}^{′} ) = \frac{1 - {m}^{′2}}{1 + {m}^{′} cos {ω}_{d} n + {v}_{offset}} \qquad ( 13 )$$

### So it can be expressed by

$$\begin{matrix}{v}_{- ( ALL - 1 )} = \frac{{m}^{′2} + {m}^{′} cos {ω}_{d} n + {v}_{offset}}{1 + {m}^{′} cos {ω}_{d} n + {v}_{offset}} = {f}_{- ( ALL - 1 )} ( n ) & ( 14 ) \\ {v}_{ALL - 2} = - ( 1 + {v}_{- ( ALL - 1 )} ) = \frac{- 1 - 2 {m}^{′} cos {ω}_{d} n - {m}^{′2} + 2 {v}_{offset}}{1 + {m}^{′} cos {ω}_{d} n + {v}_{offset}} = {f}_{ALL - 2} ( n ) & ( 15 )\end{matrix}$$

This invention focuses exclusively on the co-channel interference separation problem, so we used the PLL combined with the ALL algorithm to solve the channel interferences problem. It can be separated the dominant and subdominant signals successfully. Therefore, it can be expressed the equation as:

\hat{X}₁(n)=f_{PLL}(n)·f_{ALL-2}(n)=−S₁(n)−m′²S₂(n) (16)

\hat{X}₂(n)=f_{PLL}(n)·(−f_{ALL-2}(n))=m′²S₂(n) (17)

From equation (16) and (17), it can be rewritten the dominant and subdominant signals as (18) and (19), respectively.

$$\begin{matrix}{\hat{X}}_{1} ( n ) + {\hat{X}}_{2} ( n ) = - {S}_{1} ( n ) & ( 18 ) \\ \frac{{\hat{X}}_{2} ( n )}{{m}^{′2}} = {S}_{2} ( n ) & ( 19 )\end{matrix}$$

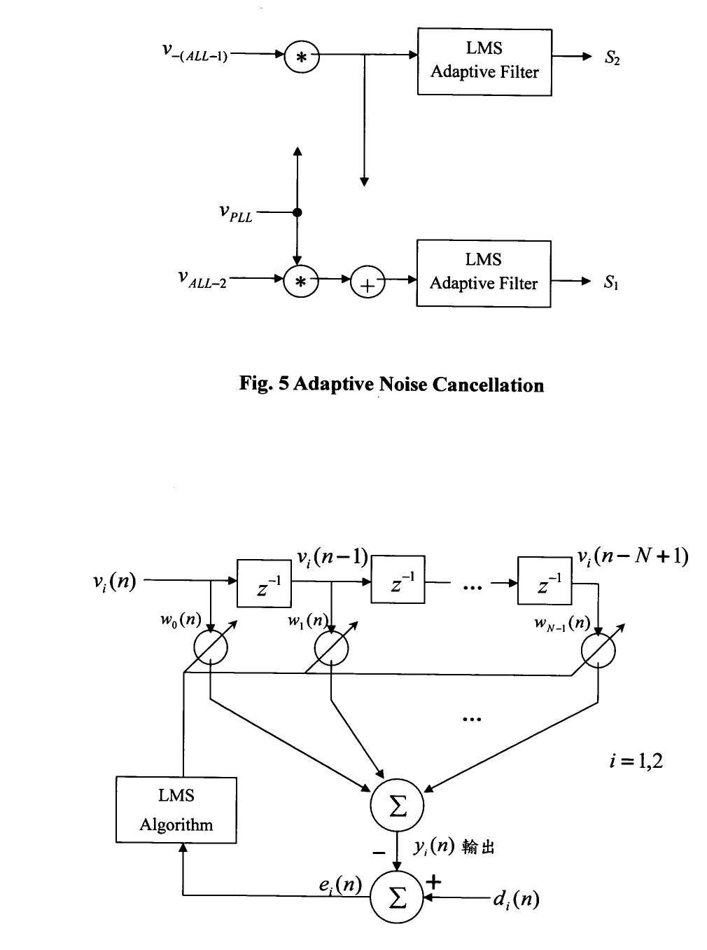

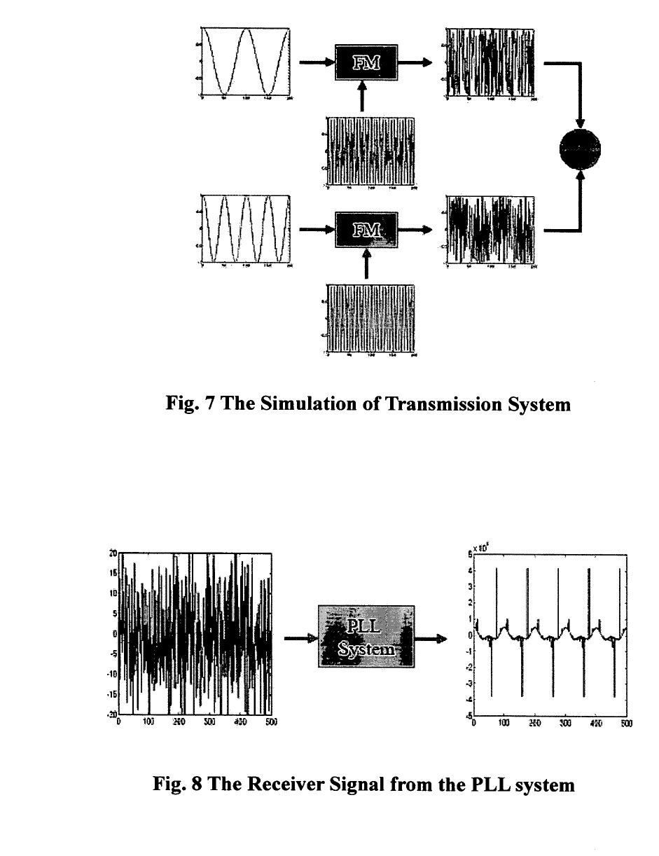

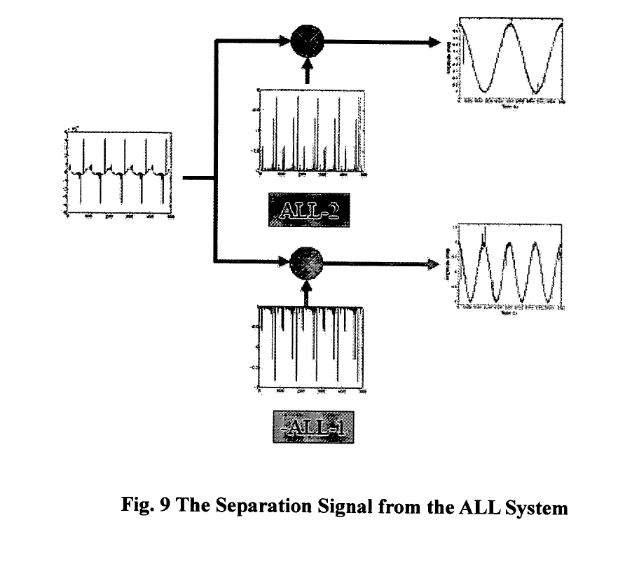

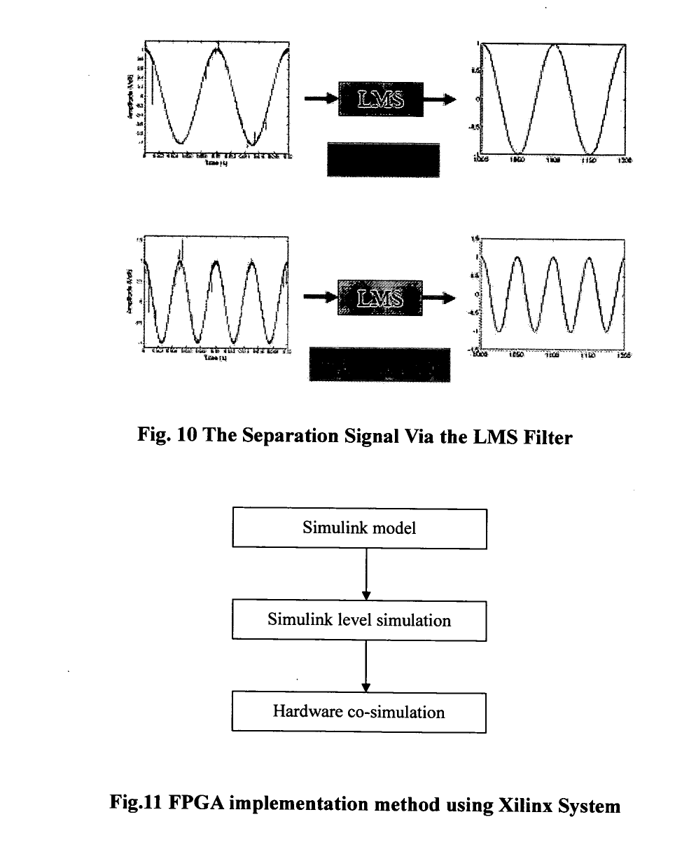

The algorithm is proposed that can separate the mixing signals and eliminated the channel interferences effect. Therefore, the separation signals have the noise distortion in the ALL output. In order to solve this noise case, we adopt the LMS filter algorithm for searching the optimal and stable value of the system in FIG. 5. The LMS system was shown in FIG. 6.

S(n)=W^{H}(n)\hat{V}(n) (20)

e(n)=d(n)−S(n) (21)

Ŵ(n+1)=Ŵ(n)+μS(n)e*(n) (22)

where S(n) is the output of the ALL system, and Ŵ(n) is the current estimate of the tap-weight vector. The desired response d(n) is supplied for processing, alongside the tap-input vector V(n). Eq. (22) is defined the estimation error e(n). Where μ is the step size, which governs the rate of convergence and ensures stability of the adaptive process.

The Simulink/Xilinx model is implemented directly to verify the above separation algorithm. The Xilinx System generator and SignalWAVe board are combined for easy implement the FPGA program and verification. FPGA implementation method using the Xilinx System Generator is shown as FIG. 11. We designed the simulink model and simulink level simulation. This model can be tested with FPGA using the Hardware co-simulation. Therefore we preferred to use Matlab for the design and the verification of the separation algorithm. Afterwards it is changed into Simulink and redrew the algorithm by using only Xilinx blocks. System Generator is a visual data flow design environment that allows the system developer to work at a suitable level of abstraction and use the same computation graph not only for simulation and verification, but also for FPGA hardware implementation.

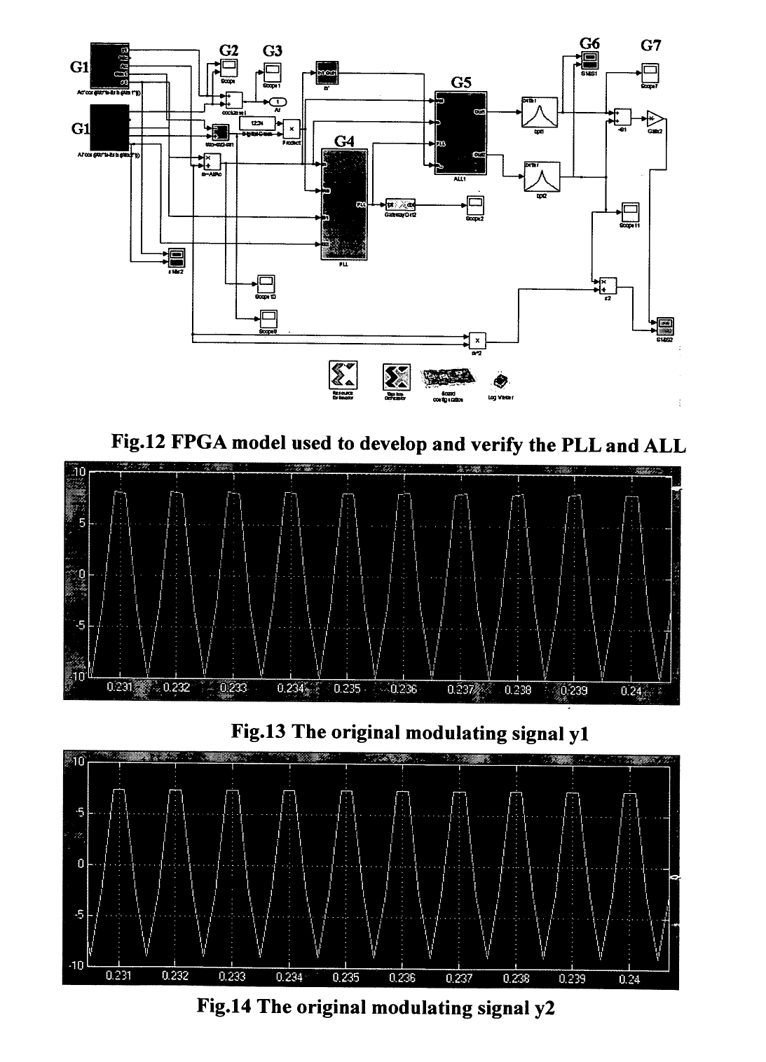

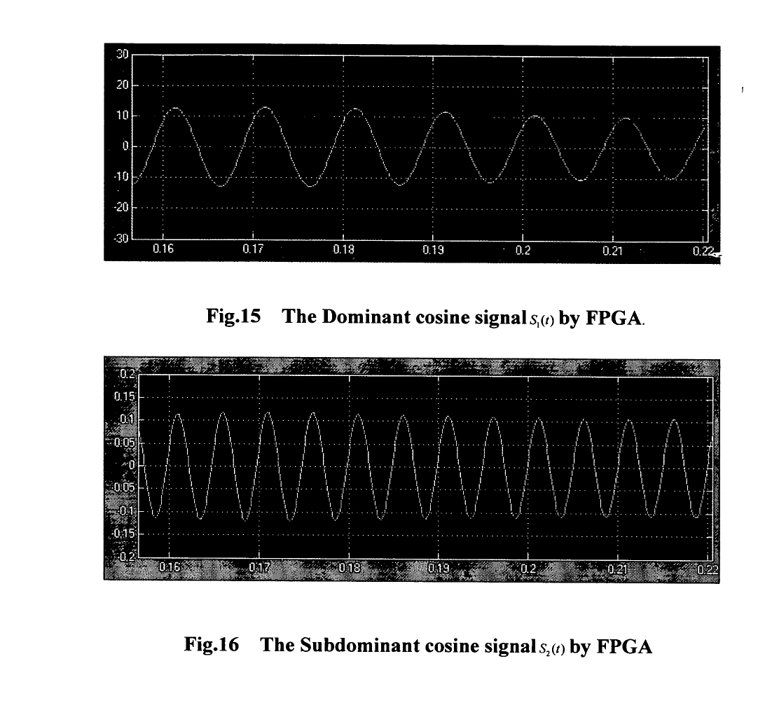

FIG. 12 shows the fully system model that was used to develop the FPGA implementation of the co-channel FM demodulation. The interference to carrier ratio signals generation GI and message signal generators G2 and G3 are constructed by using the operations from the Mathworks Simulink library. The analog filters G6 and G7 are constructed by using the operations from the Mathworks Simulink signal processing blockset. The PLL G4 and ALL G5 components are designed with Simulink block and provided in the Xilinx System Generator for the implementation with FPGA. It is implemented single PLL in order to verify ALL's performance. For the simulation plots, it is shown the same carrier frequency f_{c} for 1000 Hz and sampling frequency for 10000 Hz. The normalized interference to carrier (ICR) value of m is 1. Two original modulating signal sources are represented two cosine waveforms where operated at 100 Hz and 200 Hz, respectively. FIG. 13 to 14 are the original signal waveforms for s1(t) and s2(t), respectively. For the channel case without noise, and comparing between FIG. 13 and 15, 14 and 16, it can be clearly to see the ALL can be separated the two modulating signals and eliminated the co-channel interference effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for suppressing co-channel interference from different frequency comprising the step of:
separating two-transmission signals, wherein the system adopts the phase-locked loop (PLL) with the amplitude-locked loop (ALL) system;
suppressing co-channel interference in the receiver; and
transferring the signals through an adaptive filter for the least-mean square (LMS) algorithm to suppress the noise;
wherein the ALL is a high gain, high bandwidth servo-loop operation in the amplitude domain rather than the frequency domain; and the output of the ALL can be described by the reciprocal of the additive envelope.

2. A method for suppressing co-channel interference from different frequency by using Field Programmable Gate Array (FPGA)-based on the Amplitude-Lock Loop (ALL) separation model, comprising the step of:
using a Simulink and Xilinx System Generator for co-channel FM separated design system;
signal separated components that require Phase-Locked Loop (PLL), and ALL being designed by the Xilinx FPGA block and implemented on SignalWAVe board;
using high-level tools to map a signal separation algorithm for the reconfigurable hardware;
simulating a separation model by using Matlab/Simulink; and
comparing the performances of the outputs of the FPGA implementation and Simulink.

3. The method of claim 2, wherein a system model at the antenna consider two constant amplitude and phase signal components overlapping both in sampled time and frequecy band; the FM demodulated; the complex representation of such a signal is
$${v}_{r} ( n ) = {A}_{c} \sqrt{1 + 2 m cos {ω}_{d} n + {m}^{2}} cos ( {ω}_{c} n + {β}_{1} sin {ω}_{1} n + {tan}^{- 1} \frac{m sin {ω}_{d} n}{1 + m cos {ω}_{d} n} )$$
wherein the parameters A_{c}, m, ω_{d}, ω_{C}, β₁ sin ω₁t representes the amplitude of dominant carrier, interfering carrier to wanted carrier ratio, instantaneous frequency, carry frequency and dominant signal of modulation, respectively.
the signals being demodulated as:
$${f}_{PLL} ( n ) = \frac{1 + m cos {ω}_{d} n}{1 + 2 m cos {ω}_{d} n + {m}^{2}} {S}_{1} + \frac{{m}^{2} + m cos {ω}_{d} n}{1 + 2 m cos {ω}_{d} n + {m}^{2}} {S}_{2}$$
S₁, S₂, and n are the dominant signal, subdominant signal, and discrete time, respectively;
making small the AGC and ALL system found in the bandwidth of the AGC loop so that the instantaneous variations m cos ω_{d}n of will pass through unmodified; since the higher frequency terms can't pass through the integrator and the feedback control voltage ν_{fb} defined as:
$${v}_{fb} = \frac{1}{{A}_{c} \sqrt{1 + {m}^{2}}}$$
defining the following parameter:
$${m}^{′} = \frac{2 m}{1 + {m}^{2}}$$
$${v}_{n} = {m}^{′2} + m cos {ω}_{d} n + {v}_{offset} . \\ {v}_{k} = 1 + {m}^{′} cos {ω}_{d} n + {v}_{offset}$$
$${f}_{ALL} ( {m}^{′} ) = \frac{1 - {m}^{′2}}{1 + {m}^{′} cos {ω}_{d} n + {v}_{offset}}$$
$${v}_{- ( ALL - 1 )} = \frac{{m}^{′2} + {m}^{′} cos {ω}_{d} n + {v}_{offset}}{1 + {m}^{′} cos {ω}_{d} n + {v}_{offset}} = {f}_{- ( ALL - 1 )} ( n )$$
$${v}_{ALL - 2} = - ( 1 + {v}_{- ( ALL - 1 )} ) = \frac{- 1 - 2 {m}^{′} cos {ω}_{d} n - {m}^{′2} + 2 {v}_{offset}}{1 + {m}^{′} cos {ω}_{d} n + {v}_{offset}} = {f}_{ALL - 2} ( n )$$
$${\hat{X}}_{1} ( n ) = {f}_{PLL} ( n ) \cdot {f}_{ALL - 2} ( n ) = - {S}_{1} ( n ) - {m}^{′2} {S}_{2} ( n )$$
$${\hat{X}}_{2} ( n ) = {f}_{PLL} ( n ) \cdot ( {f}_{ALL - 1} ( n ) ) = {m}^{′2} {S}_{2} ( n )$$
$${\hat{X}}_{1} ( n ) + {\hat{X}}_{2} ( n ) = - {S}_{1} ( n )$$
$$\frac{{\hat{X}}_{2} ( n )}{{m}^{′2}} = {S}_{2} ( n )$$
then:
S(n)=W^{H}(n)\hat{V}(n)
e(n)=d(n)−S(n)
Ŵ(n+1)=Ŵ(n)+μS(n)e*(n)
where S(n) is the output of the ALL system, and Ŵ(n) is the current estimate of the tap-weight vector; the desired response d(n) is supplied for processing, alongside the tap-input vector V(n); the estimation error is e(n), wherein μ is the step size, which governs the rate of convergence and ensures stability of the adaptive process.
